(19) United States
(12) Patent Application Publication
(10) Pub. No.: US 2003/0080169 A1
(43) Pub. Date: May 1, 2003

(54) Bicycle carrier adapted to be used on a vertically orientated vehicle article carrier

(76) Inventors: Donald L. Munoz, Bloomfield Hills, MI (US); Brett J. Borella, Bloomfield Hills, MI (US); Gerard J. Kmita, Allen Park, MI (US)

Correspondence Address: HARNESS, DICKEY & PIERCE, P.L.C., P.O. BOX 828, BLOOMFIELD HILLS, MI, 48303, US

(21) Appl. No.: 10/047,937

(22) Filed: Oct. 29, 2001

(51) Int. Cl. B60R 9/048; B60R 11/00

(52) U.S. Cl. 224/492; 224/501; 224/513; 224/324; 224/924

(57) ABSTRACT

A bicycle carrier adapted to be secured to an article carrier portion of an existing vehicle article carrier so as to carry the bicycle supported thereon in a vertical orientation over a liftgate of a vehicle, and normal to an outer surface of the liftgate. The bicycle carrier includes a wheel supporting member for engaging one wheel of a bicycle when the bicycle is placed in a vertical orientation. A frame supporting assembly engages a portion of the frame to hold the bicycle to the bicycle carrier. The bicycle carrier permits a single individual to load and unload a bicycle from the bicycle carrier without being required to lift the bicycle up onto the roof of a vehicle. Since the bicycle is supported at an angle generally normal to the liftgate, visibility through the rear window of the liftgate is also improved when a bicycle is being supported on the bicycle carrier.

### FIELD OF THE INVENTION

This invention relates to bicycle carriers, and more particularly to a bicycle carrier adapted to support a bicycle thereon in a vertical orientation adjacent to a liftgate of the vehicle.

### BACKGROUND OF THE INVENTION

A wide variety of bicycle carriers have been developed for transporting bicycles on exterior surfaces of a motor vehicle. Frequently, such bicycle carriers are secured to an existing vehicle article carrier component, such as one or more cross bars of an existing vehicle article carrier supported over a roof portion of the vehicle. This requires the user to lift the bicycle up onto the roof of the vehicle and then to secure it to the bicycle carrier. As will be appreciated, this typically requires some form of step stool or ladder, in addition to a fair degree of physical strength to hoist the bicycle overhead onto the roof of the vehicle. Often, two individuals are required to perform this step. Removing the bicycle requires the same steps but in a reverse order.

Present day vehicles such as sport utility vehicles and minivans now can be used with a vehicle article carrier having an article supporting portion which can be positioned over the liftgate of the vehicle. It would be highly desirable to provide a bicycle carrier that is adapted to be secured to this article carrying portion of an existing vehicle article carrier such that a bicycle could be loaded onto the bicycle carrier without the user being required to lift the bicycle up onto the roof of the vehicle. By allowing the bicycle to be loaded onto the bicycle carrier while the user is standing on the ground, this would significantly ease the loading and unloading of the bicycle from the bicycle carrier. Furthermore, in many instances it would enable a single person to load and unload a bicycle from the bicycle carrier.

Accordingly, it is a principal object of the present invention to provide a bicycle carrier specifically adapted for use with existing vehicle article carriers which include an article carrying portion disposed over a liftgate of the vehicle. More specifically it is a principal object to provide a bicycle article carrier adapted to be used with such an existing vehicle article carrier as described above, and wherein the bicycle can be rested in a vertical orientation on a portion of the bicycle carrier by one person, while the same person secures the frame of the bicycle to the bicycle carrier. Such a bicycle carrier would significantly improve the ease with which a single person can load and unload a bicycle from the bicycle carrier.

It is a further object of the present invention to provide a bicycle carrier as described immediately above in which the components which engage and support the bicycle can be folded into a compact arrangement when the bicycle carrier is not in use.

It is still a further object of the present invention to provide a bicycle carrier, as described above, which does not interfere with operation of the liftgate when no bicycle is being supported on the bicycle carrier.

### SUMMARY OF THE INVENTION

The present invention is directed to a bicycle carrier which is particularly adapted to be used with an existing vehicle article carrier which has an article carrying portion disposed over a liftgate of the vehicle. The bicycle carrier is adapted to be secured to existing structure of the vehicle article carrier, such as one or more cross bars thereof, such that the bicycle carrier extends in a generally vertical orientation over the liftgate of the vehicle.

The bicycle carrier includes an elongated support rail forming a channel. At the lower end thereof, a foldable support member is secured to the support rail. The foldable support member can be folded out into an operative position and used to engage a wheel of the bicycle when the bicycle is lifted up and placed thereon and against the elongated support rail.

In one preferred embodiment, the foldable support member comprises a generally U-shaped component which is pivotally secured to the lower end of the support rail. When folded up into its inoperative position, the supporting member extends generally parallel to the elongated support rail. However, when folded into its operative position, it extends generally perpendicularly from the elongated support rail and supports substantially the entire weight of a bicycle placed thereon.

A frame supporting assembly includes a frame supporting member operably secured to the elongated support rail and movable pivotally relative to the elongated support rail. A clamp assembly is carried on the frame supporting member for clampingly engaging a portion of the frame of a bicycle positioned on the bicycle carrier. The frame supporting assembly helps to hold the bicycle stationary against the elongated support rail and on the foldable wheel support component while the bicycle is being transported on the vehicle.

It is a principal advantage of the bicycle carrier of the present invention that a single individual can lift a bicycle up onto the foldable wheel supporting component and then, with one hand, affix the frame supporting assembly to a portion of the frame. Accordingly, there is no need to attempt to lift the bicycle up over a roof portion of the vehicle. The bicycle carrier of the present invention thus provides a means for transporting a bicycle in a vertical orientation adjacent to a liftgate of the vehicle and significantly adds to the convenience in loading and unloading of the bicycle from the bicycle carrier.

### BRIEF DESCRIPTION OF THE DRAWINGS

The present invention will become more fully understood from the detailed description and the accompanying drawings, wherein:

FIG. 1 is a perspective view of a portion of a vehicle having a rear liftgate, with a bicycle carrier in accordance with a preferred embodiment of the present invention secured to an article supporting portion of an existing vehicle article carrier secured to the vehicle, and further showing a bicycle being supported on the bicycle carrier;

FIG. 2 is a perspective view of the bicycle carrier of the present invention detached from the article supporting portion of the vehicle article carrier of FIG. 1;

FIG. 3 is a plan view of the bicycle carrier of FIG. 2;

FIG. 4 is a perspective view of the support bracket for securing the foldable wheel supporting member pivotally to the elongated support rail of the bicycle carrier;

FIG. 5 is an exploded perspective view of a frame engaging assembly of the present invention;

FIG. 6 is a perspective view of a clamp assembly carried by the frame engaging assembly;

FIG. 7 is a rear perspective view of the clamp assembly of FIG. 6; and

FIG. 8 is a partial side cross sectional view of the wheel supporting member secured to the clamp assembly, in accordance with section line 8-8 in FIG. 3.

### DETAILED DESCRIPTION OF THE PREFERRED EMBODIMENTS

The following description of the preferred embodiment(s) is merely exemplary in nature and is in no way intended to limit the invention, its application, or uses.

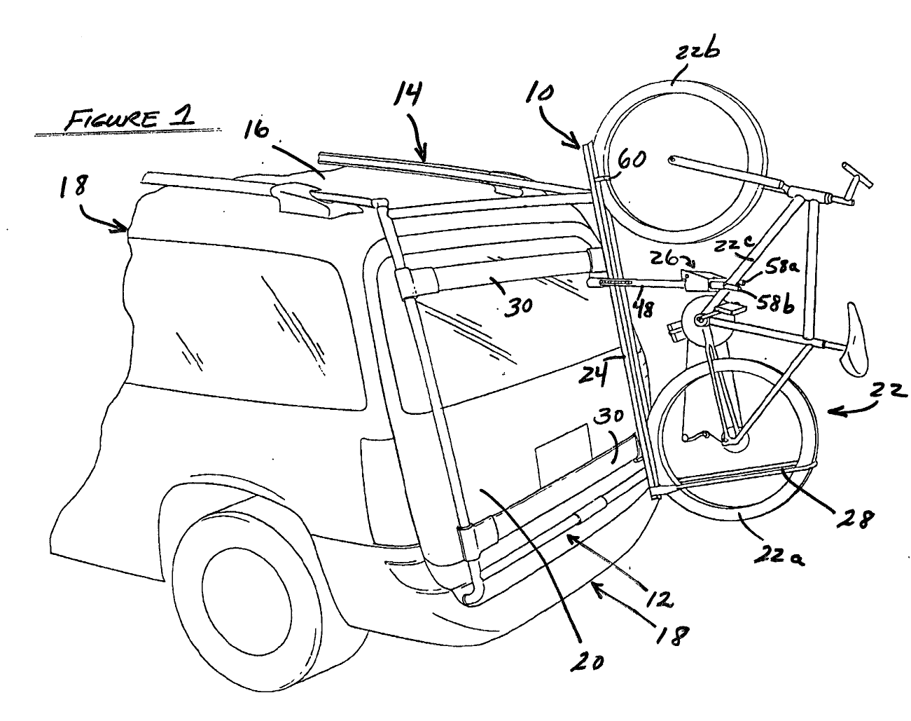

Referring to FIG. 1, there is shown a bicycle carrier 10 in accordance with a preferred embodiment of the present invention. The bicycle carrier 10 is adapted to be secured to an article-supporting portion 12 of an existing vehicle article carrier 14. The vehicle article carrier 14 is secured to an outer body surface 16 of a motor vehicle 18 such that the article supporting portion 12 extends over a liftgate 20 of the vehicle 18. Such an existing vehicle article carrier is disclosed in co-pending U.S. application Ser. No. 09/698,761, the disclosure of which is hereby incorporated by reference.

It is a principal advantage of the present invention that the bicycle carrier 10 allows a bicycle 22 to be supported in a vertical orientation over, but spaced apart from, the liftgate 20 of the vehicle 18. Accordingly, loading and unloading of the bicycle 22 from the bicycle carrier 10 does not require a user to lift the bicycle 22 onto the roof area of the vehicle 18. This allows an individual to easily load the bicycle 22 onto the bicycle carrier 10 without the assistance of a second individual.

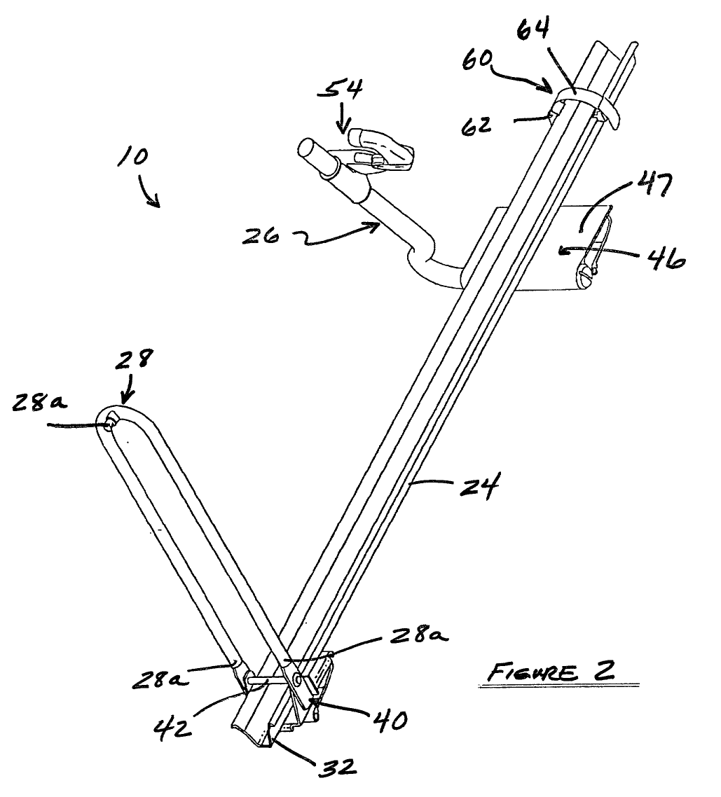

Referring further to FIGS. 1 and 2, the bicycle carrier 10 generally includes an elongated support rail 24, a frame engaging assembly 26 and a wheel supporting member 28. The wheel supporting member 28 includes a locking post 28a for securing the member 28 in a folded (non-use) position. This feature will be described in greater detail in the following paragraphs.

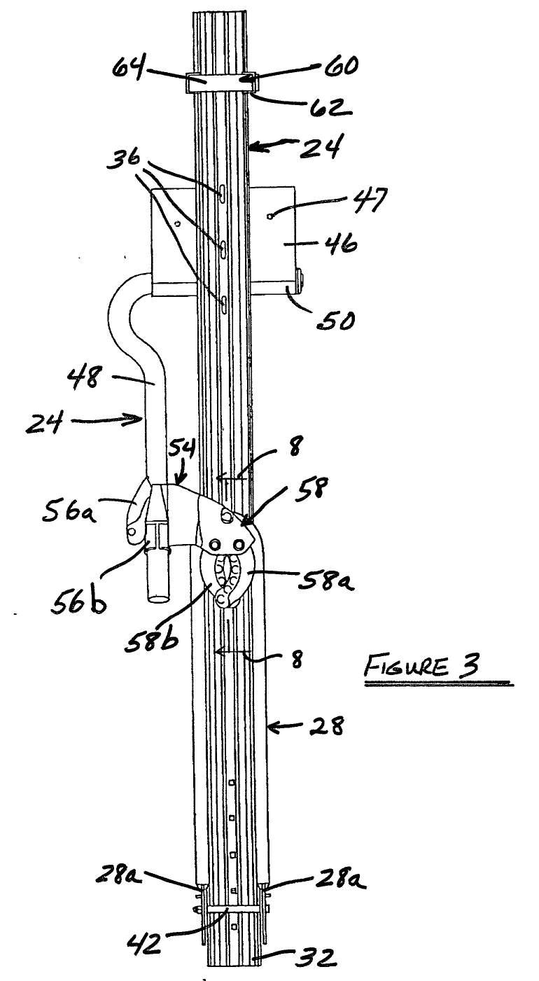

The elongated support rail 24 is secured to preferably a pair of cross bars 30 of the article supporting portion 12 of the article carrier 14 by clamps or any other suitable means. While two such cross bars 30 are illustrated, it would be appreciated that a lower end 32 of the elongated support rail 24 may just as readily be secured to a bumper 34 of the vehicle 18 if only one cross bar 30 is present. With brief reference to FIG. 3, the elongated support rail 24 includes a plurality of openings 36 formed in a bottom wall 38 thereof for facilitating attachment of the support rail 24 to the cross bars 30.

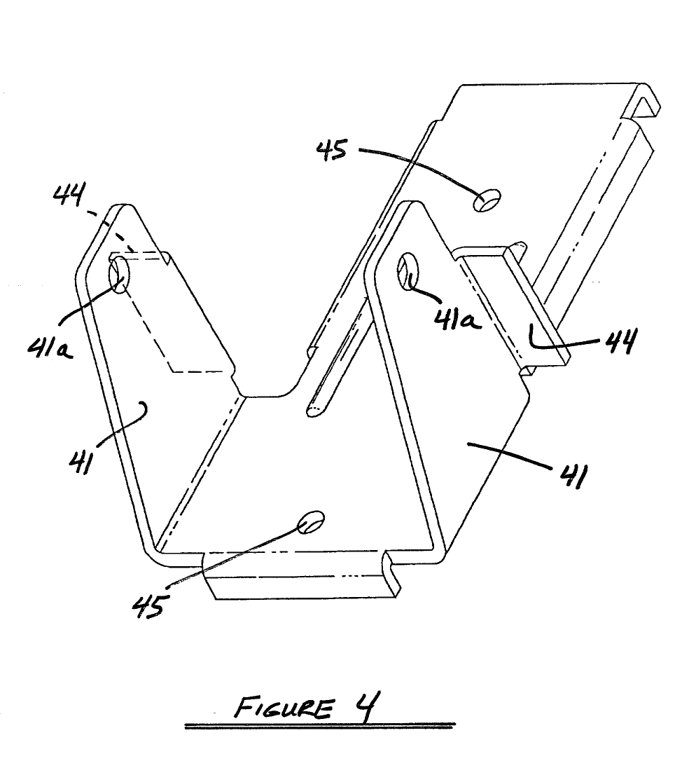

With further reference to FIGS. 2-4, the wheel supporting member 28 forms a generally U-shaped component having a pair of lower ends 28a. The lower ends 28a are secured to flanges 41 of a support bracket 40 via a pivot pin 42. The pivot pin 42 extends through openings 41a in each of the flanges. This support bracket 40 is also shown in FIG. 4 and comprises a generally U-shaped member having a base 40a and stop portions 44 which limit pivotal movement of the wheel supporting member 28 to a position preferably extending generally normal to the elongated support rail 24. The support bracket 40 is secured to the elongated support rail 38 by threaded fasteners or any other suitable means extending through openings 45 in the base 40a and one or more of the openings 36 adjacent the lower end 32 of the elongated support rail 24.

With further reference to FIGS. 2, 3 and 5, the frame supporting assembly 26 can be seen in greater detail. Frame supporting assembly 26 includes a plate 46 which is secured to the elongated support rail 24 via suitable fasteners extending through openings 47 in the plate and the openings 36 in the support rail. A tubular frame supporting element 48 is pivotally supported from the plate 46 such that the element 48 can be lifted into a position extending outwardly of the support rail 24 or folded down into a position generally parallel to the support rail 24. This is facilitated by a lower end 48a of the frame supporting element 48 being disposed within a sleeve 50 of the plate 46.

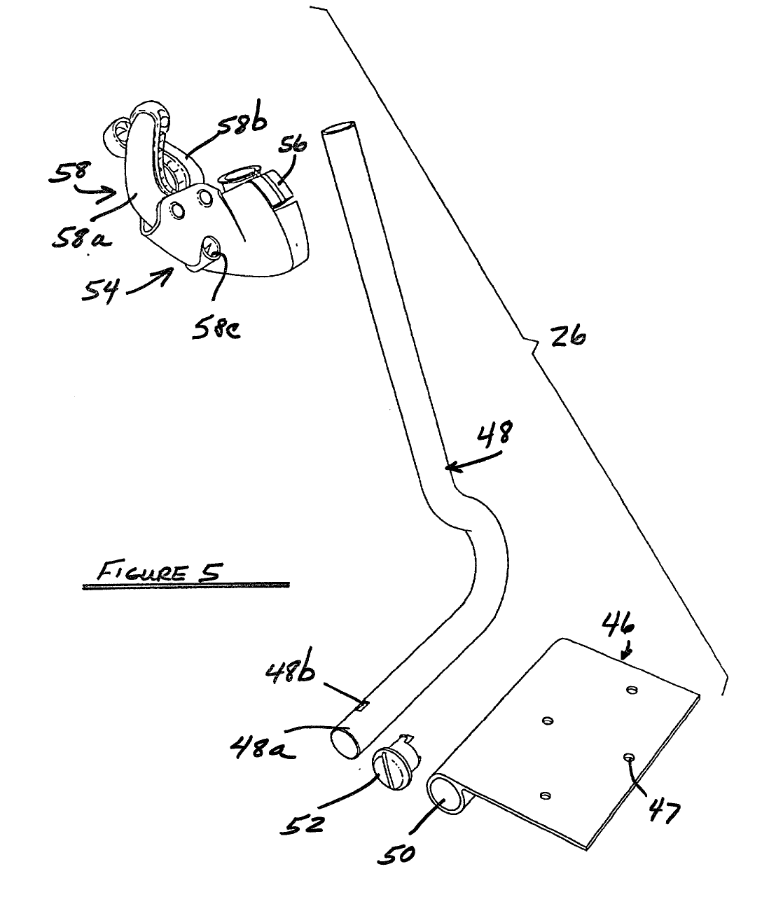

Referring further to FIGS. 2 and 5, the frame supporting assembly 26 includes an end cap 52 adapted to be inserted into the lower end 48a of the frame supporting element 48 after the lower end is inserted into the tubular sleeve 50 of the plate 46. End cap 52 includes a pair of flexible arm portions 52a (only one being visible) which engage with openings 48b in the lower end portion 48a to thus prevent the element 52 from being pulled out of the sleeve 50 once assembled thereto.

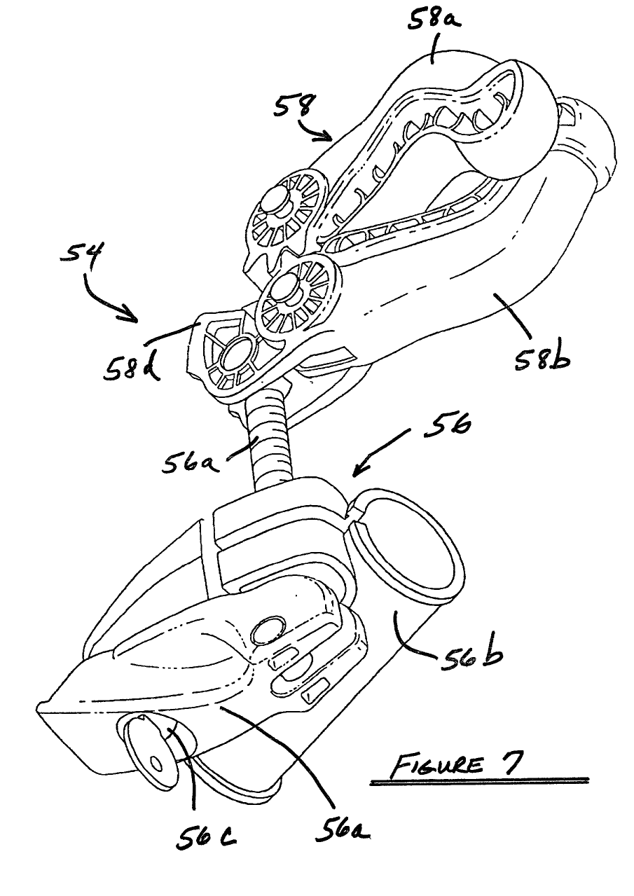

FIGS. 5, 6 and 7 also illustrate a clamp assembly 54 carried by the frame supporting element 48. The clamp assembly 54 engages a frame portion of the bicycle 22 to help maintain the bicycle in a vertical orientation and against the elongated support rail 24. The clamp assembly 54 is commercially available from Mont Blanc Industri AB, of Toarpsdal, Sweden. The clamping assembly 54 includes a first clamping subassembly 56 which can be used to adjustably position the clamp assembly 54 along the frame supporting element 48. This first clamp assembly 56 includes a threaded member 56a which is coupled to a second clamping assembly 58. A second clamping assembly 58 includes a pair of jaws 58a and 58b adapted to engage the frame portion of the bicycle 22. The jaws 58a and 58b are opened and closed by a locking lever 56a. Tightening of the locking lever 56a not only causes the jaws 58a and 58b to be drawn tight around a frame portion of a bicycle, but also tightens a split collar 56b on the tubular frame supporting element 48. A lock 56c prevents the locking lever 56 from being rotated. The ability to adjustably position the clamp assembly 54 thus allows bicycles of varying frame sizes to be accommodated on the bicycle carrier 10.

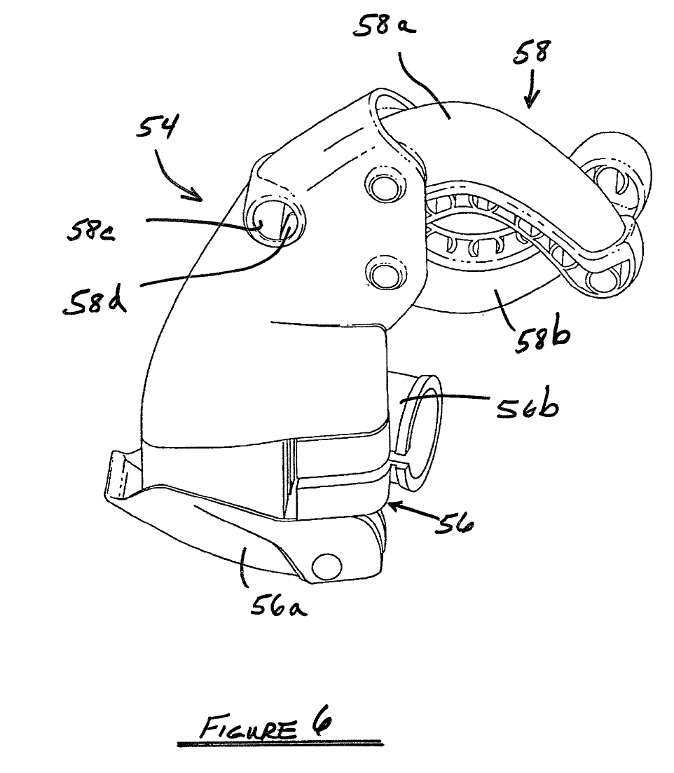

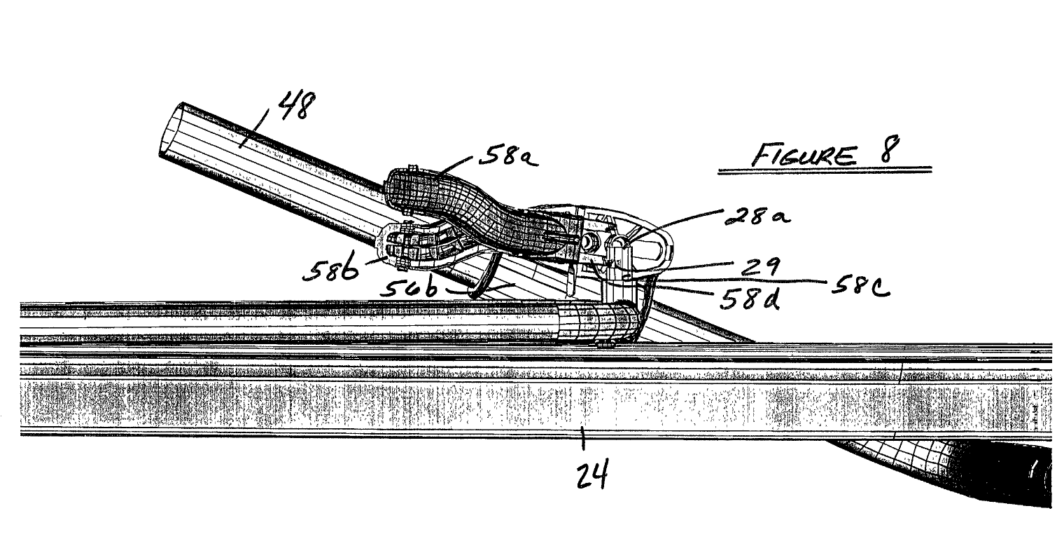

The second clamping assembly 58 also includes a recess 58c which receives the locking post 28a when the wheel supporting member 28 is in its folded orientation shown in FIG. 3. With specific reference to FIGS. 6, 7 and 8, one of the jaws 58b has a flange 58d which engages with a notch 29 of the locking post 28a when the jaws 58a and 58b are fully closed and the locking post is present within the recess 58c. In this manner the wheel supporting member 28 and the frame engaging assembly 26 can be secured to one another and held in the orientation shown in FIG. 3 when the bicycle carrier 10 is not in use.

For holding the bicycle carrier 10 to one or both of the cross bars 30, a clamp such as disclosed in U.S. application Ser. No. 09/865,237, filed May 25, 2001, incorporated by reference herein, may be used to allow the elongated support rail 24 to be secured to one or both of the cross bars 30. However, it will be appreciated that any other suitable intermediate structure capable of being attached to the cross bars and capable of being secured via suitable external fastening elements to the elongated support rail 24 may be employed. Still further, it is anticipated that the bicycle carrier 10 of the present invention could be supported entirely from the bumper, or possibly even from a hitch assembly secured to a frame portion of the vehicle 18 via a suitable intermediate component which engages the hitch and also provides a point of attachment to the elongated support rail 24.

FIG. 3 illustrates the bicycle carrier 10 with the wheel supporting member 28 and the frame supporting element 48 folded generally parallel to the elongated support rail 24. It will be appreciated when the frame supporting element 48 and the wheel supporting member 28 are in these positions, bicycle carrier 10 forms a compact assembly which can be easily maintained on a vehicle.

Referring further to FIGS. 2 and 3, a strap 60 is preferably also included for allowing the rear wheel of the bicycle 22 to be secured positively to the elongated support rail 24. The strap 60 includes a conventional locking assembly 62 for allowing a strap portion 64 thereof to be adjustably tightened over the wheel. Alternatively, a simple nylon or length of flexible yet strong straping may be disposed through a pair of slots formed in the elongated support rail 24 and held with a hook and loop style fastener such as Velcro®, or any other form of suitable fastening means.

Referring further to FIG. 1, in operation the user lifts the bicycle 22 up into the orientation shown in FIG. 1 and places a rear wheel 22a thereof in the wheel supporting component 28. The user then orientates the bicycle 22 so that the front wheel 22b is placed within the elongated support rail 24. With one hand, the user then lifts up the frame supporting element 48 of the frame supporting assembly 26 and secures the clamping jaws 58a and 58b of clamp 58 over a frame tube 22c of the bicycle 22. The clamp assembly 54 can then be tightened on the frame supporting element 48. Lastly, the strap 60 can be tightened over the rear wheel 22.

Bicycle carrier 10 of the present invention thus provides a means for enabling a single individual to place and secure a bicycle thereon without the assistance of a second individual, and further without being required to lift the bicycle up onto the roof of a vehicle. Bicycle carrier 10 therefore allows much easier loading and unloading of a bicycle therefrom than many previously developed bicycle carriers. The bicycle carrier 10 further does not require any modifications to an existing vehicle article carrier or to other portions of the vehicle. Still further, the bicycle carrier 10 of the present invention allows the bicycle to be supported at an angle generally normal to the rear liftgate of a vehicle, thus significantly improving visibility through the rear window of the liftgate. It will be appreciated, however, that the bicycle carrier of the present invention could also be used with a horizontally positioned article carrier component.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bicycle carrier adapted to be secured to an article carrier structure on a motor vehicle, to support a bicycle in a vertical orientation adjacent said motor vehicle, said bicycle carrier comprising:
an elongated support rail adapted to be fixedly secured to said article carrier structure such that said support rail extends in a generally vertical orientation adjacent said motor vehicle;
a foldable wheel support adapted to be extended into an operative position extending outwardly of said support rail for engaging a wheel of said bicycle and substantially supporting said bicycle; and
a frame engaging assembly operably associated with said support rail for engaging a frame portion of said bicycle and holding said bicycle against said support rail.

2. The bicycle carrier of claim 1, wherein said foldable wheel support comprises a U-shaped component adapted to engage a portion of a wheel of said bicycle.

3. The bicycle carrier of claim 1, wherein said foldable wheel support includes:
a wheel supporting component moveable pivotally relative to said support rail and adapted to engage a portion of a wheel of said bicycle;
a mounting component, said mounting component adapted to be fixedly secured to said support rail;
wherein said foldable support wheel is pivotably coupled to said mounting component; and
wherein said mounting component includes a stop portion for limiting pivotal movement of said wheel supporting component.

4. The bicycle carrier of claim 1, wherein said frame engaging assembly includes;
a frame supporting member; and
a mounting plate fixedly secured to said elongated support rail, said frame supporting member being pivotally secured to said mounting plate to allow a degree of adjustability to accommodate bicycle frames of various sizes.

5. The bicycle carrier of claim 1, wherein said frame supporting member includes a clamp assembly for clamping onto a portion of a frame of said bicycle.

6. A bicycle carrier adapted to be secured to an article carrier structure on a motor vehicle, to support a bicycle in a vertical orientation adjacent a lift gate of said motor vehicle, said bicycle carrier comprising:
an elongated support rail adapted to be fixedly secured to said article carrier structure such that said support rail extends in a generally vertical orientation and spaced apart from said liftgate of said motor vehicle;
a foldable wheel support adapted to be extended into an operative position extending outwardly of said support rail for engaging one wheel of said bicycle and substantially supporting said bicycle when said bicycle is lifted and placed with said one wheel on said foldable wheel support in a generally vertical orientation; and
a secondary support assembly for engaging said bicycle at a position other than said one wheel to further assist in securing said bicycle in said vertical orientation.

7. The bicycle carrier of claim 6, wherein said secondary support assembly comprises:
a tube;
a clamp carried by said tube, said clamp being adapted to engage a frame portion of said bicycle; and
a support member for securing said tube to said elongated support rail.

8. The bicycle carrier of claim 7, wherein said tube is pivotally secured to said support member.

9. The bicycle carrier of claim 6, wherein said foldable wheel support comprises:
a generally U-shaped member adapted to engage a portion of said one wheel of said bicycle;
a support member secured to said support rail;
said U-shaped member being pivotally secured to said support member so as to be foldable into a position extending generally parallel to said support rail, and extended into a position extending generally normal to said support rail.

10. The bicycle carrier of claim 6, wherein said elongated support rail is comprised of a generally V-shaped component.

11. The bicycle carrier of claim 8, wherein said tube is foldable to a position generally parallel to said elongated support rail when not in use.

12. A bicycle carrier adapted to be secured to an article carrier structure on a motor vehicle, to support a bicycle in a vertical orientation adjacent a lift gate of said motor vehicle, said bicycle carrier comprising:
an elongated support rail adapted to be fixedly secured to said article carrier structure such that said support rail extends in a generally vertical orientation and spaced over but apart from said liftgate of said motor vehicle;
a foldable wheel support adapted to be extended between a stored position, wherein said foldable wheel support is disposed generally parallel to said elongated support rail, and an operative position wherein said foldable wheel is extended into an position outwardly of said support rail;
said foldable wheel support engaging one wheel of said bicycle and substantially supporting an entire weight of said bicycle when said bicycle is lifted and placed with said one wheel on said foldable wheel support in a generally vertical orientation; and
a secondary support assembly secured to said elongated support member for engaging said bicycle at a position other than said one wheel to further assist in securing said bicycle in said vertical orientation.

13. The bicycle carrier of claim 12, wherein said secondary support assembly includes a frame supporting member for engaging a portion of a frame of said bicycle.

14. The bicycle carrier of claim 12, wherein said secondary support assembly includes a clamping assembly for engaging a portion of a frame of said bicycle.

15. The bicycle carrier of claim 12, wherein said secondary support assembly includes:
a frame supporting member operably secured to said elongated support rail and moveable pivotally relative to said elongated support rail; and
a clamping assembly adjustably positionable along said frame supporting member for engaging a portion of a frame of said bicycle.

16. A bicycle carrier adapted to be secured to an article carrier structure on a motor vehicle, to support a bicycle in a vertical orientation adjacent a generally vertical wall portion of said vehicle, said bicycle carrier comprising:
a main support member adapted to be fixedly secured to said article carrier structure such that said support rail extends in a generally vertical orientation and spaced over but apart from said liftgate of said motor vehicle;
a foldable wheel support adapted to be extended between a stored position, wherein said foldable wheel support is disposed generally parallel to said main support member, and an operative position wherein said foldable wheel is extended into an position outwardly of said main support member;
said foldable wheel support engaging one wheel of said bicycle and substantially supporting an entire weight of said bicycle when said bicycle is lifted and placed with said one wheel on said foldable wheel support in a generally vertical orientation; and
a secondary support assembly operably associated with said main support member for engaging a frame portion of said bicycle to further assist in holding said bicycle against said main support member and in said generally vertical orientation.

17. The bicycle carrier of claim 16, wherein said main support member comprises an elongated support rail forming a channel.

18. The bicycle carrier of claim 16, wherein said secondary support assembly comprises:
a support element operably coupled to said main support member and moveable pivotally relative to said main support member;
a clamping assembly disposed on said support element for clamping to a frame portion of said bicycle.

19. The bicycle carrier of claim 18, wherein said support element is positionable generally parallel to said main support member when said bicycle carrier is not in use.

20. The bicycle carrier of claim 18, wherein said clamping assembly is adjustably positionable on said support element.
